(19) United States
(12) Patent Application Publication
(10) Pub. No.: US 2026/0117022 A1
(43) Pub. Date: Apr. 30, 2026

(54) Mitigation of Poly(hydroxyalkanote) Degradation in Polymeric Compositions

(71) Applicant: Danimer IPCo, LLC, Bainbridge, GA (US)

(72) Inventors: Karson Durie, Athens, GA (US); Abdala Bashir, Tallahassee, FL (US)

(21) Appl. No.: 19/156,613

(22) PCT Filed: Feb. 14, 2024
(86) PCT No.: PCT/US2024/015761

§ 371 Date: Aug. 14, 2025

Related U.S. Application Data
(60) Provisional application No. 63/485,085, filed on Feb. 15, 2023.

(51) Int. Cl. C08G 63/91

(52) U.S. Cl. CPC C08G 63/912; C08G 2230/00

(57) ABSTRACT

The present disclosure provides methods for mitigating polymer degradation in poly(hydroxyalkanoates), which include carboxylic acid end groups and monomeric repeat units which are susceptible to degradation to form unsaturated carboxylic acid by-products. The carboxylic acid end groups are reacted with an end-capping agent selected from the group consisting of carbodiimides, diisocyanates, epoxides, and mixtures thereof, and the poly(hydroxyalkanoates) are also reacted with an acid anhydride to graft side chains onto the poly(hydroxyalkanoates).

### FIELD

This disclosure relates to biodegradable polymeric compositions. More particularly, this disclosure relates to biodegradable polymeric compositions comprising poly(hydroxyalkanoates), wherein degradation of the poly(hydroxyalkanoate) is mitigated.

### BACKGROUND

Poly(hydroxyalkanoates) (PHAs) are a class of polymers that are desirably biodegradable and/or compostable. Thus, products made from poly(hydroxyalkanoates) will degrade when the product has reached the end of its lifecycle. However, poly(hydroxyalkanoates) are also susceptible to degradation through heat, shear, and hydrolysis in other circumstances outside the end-of-life cycle disposal. When this occurs, the material degrades to form monomeric components of the polymers. This degradation can cause loss of material properties, organoleptic problems, and regulatory issues.

Accordingly, it would be desirable, and an object of the present disclosure, to provide poly(hydroxyalkanoates) compositions wherein degradation of the poly(hydroxyalkanoate) due to heat, shear, and hydrolysis is mitigated or even eliminated.

### SUMMARY OF THE INVENTION

According to the present disclosure, the above and other needs are met by a method for mitigating polymer degradation in poly(hydroxyalkanoates).

In a first aspect, the present disclosure provides a method for mitigating polymer degradation in poly(hydroxyalkanoates). According to one embodiment, the method includes a first step of combining at least one poly(hydroxyalkanoate) with an end-capping agent, at least one acid anhydride, and a peroxide to form a reaction mixture comprising at least 50 weight percent of the at least one poly(hydroxyalkanoate), from about 0.01 to about 15 weight percent of the end-capping agent, from about 0.01 to about 15 weight percent of the cyclic acid anhydride, and from about 0.01 to about 0.5 weight percent of the peroxide. The at least one poly(hydroxyalkanoate) in this mixture includes carboxylic acid end groups and monomeric repeat units, which are susceptible to degradation to form unsaturated carboxylic acid by-products.

The method includes a step of reacting the end-capping agent with the carboxylic acid end groups to form end-capping groups on the at least one poly(hydroxyalkanoate). The method also includes a step of reacting the at least one acid anhydride and the peroxide with the at least one poly(hydroxyalkanoate) to graft side chains formed from the acid anhydride onto the at least one poly(hydroxyalkanoate). According to the present disclosure, the end-capping agent is made up of at least one compound selected from the group consisting of carbodiimides, diisocyanates, epoxides, and mixtures thereof, and the at least one acid anhydride is made up of a cyclic or noncyclic acid anhydride having from 3 to 40 carbon atoms.

According to certain embodiments, the at least one poly(hydroxyalkanoate) preferably has an initial weight average molecular weight before combining with the end-capping agent and the acid anhydride of at least 10,000 Daltons, as determined by ASTM 5296-19. More preferably, the at least one poly(hydroxyalkanoate) has an initial weight average molecular weight before combining with the end-capping agent and the acid anhydride, from about 20,000 Daltons to about 2,500,000 Daltons, as determined by ASTM 5296-19.

In certain embodiments, the at least one poly(hydroxyalkanoate) preferably includes 3-hydroxybutyrate monomeric repeat units, which are susceptible to degradation to form crotonic acid. In some embodiments, the at least one poly(hydroxyalkanoate) preferably includes 3-hydroxyhexanoate monomeric repeat units, which are susceptible to degradation to form hexenoic acid. In other embodiments, the at least one poly(hydroxyalkanoate) preferably includes 3-hydroxypropionate monomeric repeat units, which are susceptible to degradation to form acrylic acid. In further embodiments, the at least one poly(hydroxyalkanoate) preferably includes 4-hydroxybutyrate monomeric repeat units, which are susceptible to degradation to form 4-hydroxybutyric acid.

In some instances, the at least one poly(hydroxyalkanoate) includes polyhydroxybutyrate homopolymer. In other embodiments, the at least one poly(hydroxyalkanoate) includes poly-3-hydroxybutyrate-co-3-hydroxyvalerate. In still further embodiments, the at least one poly(hydroxyalkanoate) includes poly-3-hydroxybutyrate-co-3-hydroxyvalerate.

According to certain embodiments, the at least one poly(hydroxyalkanoate) preferably includes from about 0.1 to about 25 mole percent monomer residues of a 3-hydroxyalkanoate selected from the group consisting of 3-hydroxyhexanoate, 3-hydroxyoctanoate, 3-hydroxydecanoate, and mixtures thereof.

In some embodiments, the at least one poly(hydroxyalkanoate) preferably includes a polyhydroxyalkanoate terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydroxyalkanoate selected from the group consisting of 3-hydroxyoctanoate, 3-hydroxydecanoate, and mixtures thereof.

In some embodiments, the end-capping agent preferably includes at least one carbodiimide according to Formula (I)

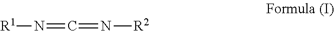

wherein R¹ and R² independently comprise an aliphatic or aromatic group, optionally substituted with one or more heteroatoms selected from the group consisting of N, O, S, and P.

In accordance with some embodiments, the end-capping agent preferably includes at least one polymeric carbodiimide having a molecular weight from about 20 to about 2000 Daltons, as determined by ASTM 5296-19.

In other embodiments, the end-capping agent preferably includes at least one diisocyanate according to Formula (II)

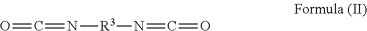

wherein R³ comprises an aliphatic or aromatic group having from 1 to 20 carbon atoms.

In some embodiments, the end-capping agent preferably includes at least one aliphatic or aromatic epoxide having from 2 to 200 carbon atoms.

In some instances, the end-capping agent preferably includes at least one poly(epoxide) having a molecular weight from about 40 to about 5000 Daltons as determined by ASTM 5296-19.

In accordance with certain embodiments of the present disclosure, the at least one acid anhydride preferably includes an aliphatic cyclic acid anhydride having from 3 to 40 carbon atoms. In some embodiments, the at least one acid anhydride preferably includes at least one cyclic anhydride selected from the group consisting of maleic anhydride, succinic anhydride, octadecenyl succinic anhydride, and mixtures thereof.

In some embodiments, the peroxide is preferably an organic peroxide. More preferably, the peroxide is selected from the group consisting of lauryl peroxide, dicumyl peroxide, and 2,5-Bis(tert-butylperoxy)-2,5-dimethylhexane.

According to certain embodiments, the reacting step is preferably carried out in an extruder. In other embodiments, the reacting step is preferably carried out in a continuous mixer. In some embodiments, the reacting step is preferably carried out at a temperature from about 120° C. to about 200° C.

In another embodiment, the present disclosure provides a polymer composition, which is made up of least 50 weight percent of the end-capped and grafted poly(hydroxyalkanoate) formed according to the aforementioned method.

In some embodiments, the reaction of carbodiimide with poly(hydroxyalkanoate) is characterized by an increase in molecular weight as measured by ASTM 5296-19, reduction in acid value as measured by titration with potassium hydroxide (KOH) solution, and formation of new carbon-nitrogen bonds as observed by FT-IR spectroscopy.

### BRIEF DESCRIPTION OF THE DRAWINGS

Further advantages of the disclosure are apparent by reference to the detailed description when considered in conjunction with the figure, wherein:

FIG. 1 is a set of FT-IR spectra of poly(hydroxyalkanoate) with and without reaction with a carbodiimide end-cap according to one embodiment of the present disclosure.

### DETAILED DESCRIPTION

The present disclosure provides methods for preparing biodegradable polymeric compositions comprising poly(hydroxyalkanoates) wherein the poly(hydroxyalkanoates) possess improved resistance to undesired degradation. The present disclosure also provides biodegradable polymeric compositions prepared in accordance with such methods.

Poly(hydroxyalkanoates) are susceptible to degradation through heat, shear, and hydrolysis, leading to the degradation of the material into monomeric components of the polymers. For instance, if the poly(hydroxyalkanoates) comprise 3-hydroxybutyrate monomeric repeat units, these repeat units are susceptible to degradation to form crotonic acid. If the poly(hydroxyalkanoates) comprise 3-hydroxyhexanoate monomeric repeat units, these repeat units are susceptible to degradation to form hexenoic acid. If the poly(hydroxyalkanoates) comprise 3-hydroxypropionate monomeric repeat units, these repeat units are susceptible to degradation to form acrylic acid. If the poly(hydroxyalkanoates) comprise 4-hydroxybutyrate monomeric repeat units, these repeat units are susceptible to degradation to form 4-hydroxybutyric acid.

The formation of such degradation products can cause loss of material properties (such as strength and molecular weight), organoleptic problems, and regulatory issues due to the presence of materials such as crotonic acid in the polymer composition.

In response to these difficulties, the present disclosure first provides a method for mitigating polymer degradation in poly(hydroxyalkanoates) using end-capping and grafting. According to one embodiment, the method comprises at least a first step of combining at least one poly(hydroxyalkanoate) with an end-capping agent, at least one acid anhydride, and a peroxide to form a reaction mixture comprising at least 50 weight percent of the at least one poly(hydroxyalkanoate), from about 0.01 to about 15 weight percent of the end-capping agent, from about 0.01 to about 15 weight percent of the cyclic acid anhydride, and from about 0.01 to about 0.5 weight percent of the peroxide.

The method includes a step of reacting the end-capping agent with the carboxylic acid end groups to form end-capping groups on the at least one poly(hydroxyalkanoate). The method also includes a step of reacting the at least one acid anhydride and peroxide with the at least one poly(hydroxyalkanoate) to graft side chains formed from the acid anhydride onto the at least one poly(hydroxyalkanoate). According to the present disclosure, the end-capping agent is made up of at least one compound selected from the group consisting of carbodiimides, diisocyanates, epoxides, and mixtures thereof, and the at least one acid anhydride is made up of a cyclic or noncyclic acid anhydride having from 3 to 40 carbon atoms.

A variety of poly(hydroxyalkanoates) may be end-capped according to the present disclosure, including homopolymers, copolymers, and terpolymers.

For instance, in certain embodiments, the at least one poly(hydroxyalkanoate) may comprise polyhydroxybutyrate homopolymer.

In other embodiments, the at least one poly(hydroxyalkanoate) may comprise a copolymer such as poly-3-hydroxybutyrate-co-3-hydroxyvalerate or poly-3-hydroxybutyrate-co-3-hydroxyvalerate. More generally, the poly(hydroxyalkanoate) copolymer, in some embodiments, may comprise from about 0.1 to about 25 mole percent monomer residues of a 3-hydroxyalkanoate selected from the group consisting of 3-hydroxyhexanoate, 3-hydroxyoctanoate, 3-hydroxydecanoate, and mixtures thereof.

In still other embodiments, the at least one poly(hydroxyalkanoate) may comprise a polyhydroxyalkanoate terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydroxyalkanoate selected from the group consisting of 3-hydroxyoctanoate, 3-hydroxydecanoate, and mixtures thereof.

A mixture of two or more of the foregoing poly(hydroxyalkanoates) may also be end-capped according to the present method.

The at least one poly(hydroxyalkanoate) typically has an initial weight average molecular weight before combining with the end-capping agent, acid anhydride, and peroxide) of at least 10,000 Daltons, as determined by ASTM 5296-19. More preferably, the at least one poly(hydroxyalkanoate) has an initial weight average molecular weight from about 20,000 Daltons to about 2,500,000 Daltons, as determined by ASTM 5296-19, before combining with the end-capping agent, acid anhydride, and peroxide.

As for the end-capping agent, the end-capping agent comprises at least one compound selected from the group consisting of carbodiimides, diisocyanates, epoxides, and mixtures thereof.

For example, in certain embodiments, the end-capping agent may comprise at least one carbodiimide according to Formula (I)

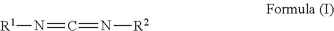

In this carbodiimide, each of R¹ and R² independently comprises an aliphatic or aromatic group, optionally substituted with one or more heteroatoms selected from the group consisting of N, O, S, and P. While the overall size of this carbodiimide may vary, the carbodiimide is, in some embodiments, a polymeric carbodiimide having a molecular weight from about 20 to about 5000 Daltons, more preferably from about 300 to about 2000 Daltons, as determined by ASTM 5296-19.

In some embodiments, each of R¹ and R² more preferably comprises an aromatic group. An example of a suitable carbodiimide is STABAXOL P, available from Lanxess AG of Germany. While the exact composition of STABAXOL P is not known, it is believed to comprise an aromatic carbodiimide, wherein the aromatic groups are substituted with isopropyl groups.

In other embodiments, the end-capping agent may comprise at least one diisocyanate according to Formula (II)

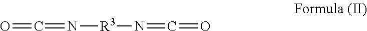

wherein R³ comprises an aliphatic or aromatic group having from 1 to 20 carbon atoms.

In some embodiments, this end-capping agent preferably comprises at least one aliphatic or aromatic epoxide having from 2 to 200 carbon atoms.

In other embodiments, the end-capping agent may comprise at least one poly(epoxide) having a molecular weight from about 40 to about 5000 Daltons, more preferably from about 500 to about 3000 Daltons, as determined by ASTM 5296-19.

As noted above, the grafting is carried out with an acid anhydride and a peroxide. In general, the acid anhydride may be either a cyclic or a noncyclic acid anhydride with 3 to 40 carbon atoms. In some instances, the at least one acid anhydride preferably comprises at least one cyclic anhydride selected from the group consisting of maleic anhydride, succinic anhydride, octadecenyl succinic anhydride, and mixtures thereof.

In some embodiments, the peroxide is preferably an organic peroxide. More preferably, the peroxide is selected from the group consisting of lauryl peroxide, dicumyl peroxide, and 2,5-Bis(tert-butylperoxy)-2,5-dimethylhexane.

Both the end-capping reaction and the acid anhydride grafting reaction are preferably carried out at a temperature from about 120° C. to about 200° C., more preferably from about 130° C. to about 170° C.

According to certain embodiments, one or both of these reaction steps are preferably carried out in an extruder. In other embodiments, one or both of these reaction steps are preferably carried out in a continuous mixer.

In another embodiment, the present disclosure provides polymer composition, which is made up of least 50 weight percent of the end-capped and grafted poly(hydroxyalkanoate) formed according to the aforementioned method.

In certain embodiments, the grafting reacting step of the grafting method is preferably carried out in an extruder. In other embodiments, the grafting reacting step is preferably carried out in a continuous mixer. In some embodiments, the reacting step is preferably carried out at a temperature from about 120° C. to about 200° C., more preferably from about 130° C. to about 170° C.

In some embodiments, the polymer and other reactive components also include other additives, including but not limited to nucleators, lubricants, other biodegradable polymers, processing aids, fillers, antioxidants, and mixtures thereof.

In other embodiments, the extent of degradation prevention/acid mitigation is identified by changes in the percent change of molecular weight as determined by ASTM 5296-19, Hunter color determined by ASTM E1347, changes in FTIR spectra via ASTM E168-16, and determination of acid values by ASTM D7253-16.

The present disclosure is also further illustrated by the following embodiments:

Embodiment 1. A method for mitigating polymer degradation in poly(hydroxyalkanoates), the method comprising:
combining at least one poly(hydroxyalkanoate) with an end-capping agent, at least one acid anhydride, and a peroxide to form a reaction mixture comprising at least 50 weight percent of the at least one poly(hydroxyalkanoate), from about 0.01 to about 15 weight percent of the end-capping agent, from about 0.01 to about 15 weight percent of the cyclic acid anhydride, and from about 0.01 to about 0.5 weight percent of the peroxide, wherein the at least one poly(hydroxyalkanoate) comprises carboxylic acid end groups and monomeric repeat units which are susceptible to degradation to form unsaturated carboxylic acid by-products;
reacting the end-capping agent with the carboxylic acid end groups to form end-capping groups on the at least one poly(hydroxyalkanoate); and
reacting the at least one acid anhydride and the peroxide with the at least one poly(hydroxyalkanoate) to graft side chains formed from the acid anhydride onto the at least one poly(hydroxyalkanoate,
wherein the end-capping agent comprises at least one compound selected from the group consisting of carbodiimides, diisocyanates, epoxides, and mixtures thereof, and
wherein the at least one acid anhydride comprises a cyclic or noncyclic acid anhydride having from 3 to 40 carbon atoms.

Embodiment 2. The method of Embodiment 1, wherein the at least one poly(hydroxyalkanoate) has an initial weight average molecular weight before combining with the end-capping agent and the acid anhydride, of at least 10,000 Daltons, as determined by ASTM 5296-19.

Embodiment 3. The method of Embodiment 1 or 2, wherein the at least one poly(hydroxyalkanoate) has an initial weight average molecular weight before combining with an end-capping agent and the acid anhydride, from about 20,000 Daltons to about 2,500,000 Daltons, as determined by ASTM 5296-19.

Embodiment 4. The method of any of the preceding Embodiments, wherein the at least one poly(hydroxyalkanoate) comprises 3-hydroxybutyrate monomeric repeat units which are susceptible to degradation to form crotonic acid.

Embodiment 5. The method of any of the preceding Embodiments, wherein the at least one poly(hydroxyalkanoate) comprises 3-hydroxyhexanoate monomeric repeat units which are susceptible to degradation to form hexenoic acid.

Embodiment 6. The method of any of the preceding Embodiments, wherein the at least one poly(hydroxyalkanoate) comprises 3-hydroxypropionate monomeric repeat units which are susceptible to degradation to form acrylic acid.

Embodiment 7. The method of any of the preceding Embodiments, wherein the at least one poly(hydroxyalkanoate) comprises 4-hydroxybutyrate monomeric repeat units which are susceptible to degradation to form 4-hydroxybutyric acid.

Embodiment 8. The method of any of the preceding Embodiments, wherein the at least one poly(hydroxyalkanoate) comprises poly-3-hydroxybutyrate-co-3-hydroxyhexanaote (P3HB-co-P3HHx).

Embodiment 9. The method of any of the preceding Embodiments, wherein the at least one poly(hydroxyalkanoate) comprises polyhydroxybutyrate homopolymer.

Embodiment 10. The method of any of the preceding Embodiments, wherein the at least one poly(hydroxyalkanoate) comprises poly-3-hydroxybutyrate-co-3-hydroxyvalerate.

Embodiment 11. The method of any of the preceding Embodiments, wherein the at least one poly(hydroxyalkanoate) comprises from about 0.1 to about 25 mole percent monomer residues of a 3-hydroxyalkanoate selected from the group consisting of 3-hydroxyhexanoate, 3-hydroxyoctanoate, 3-hydroxydecanoate, and mixtures thereof.

Embodiment 12. The method of any of the preceding Embodiments, wherein the at least one poly(hydroxyalkanoate) comprises a polyhydroxyalkanoate terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydroxyalkanoate selected from the group consisting of 3-hydroxyoctanoate, 3-hydroxydecanoate, and mixtures thereof.

Embodiment 13. The method of any of the preceding Embodiments, wherein the end-capping agent comprises at least one carbodiimide according to Formula (I)

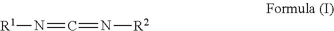

wherein R¹ and R² independently comprise an aliphatic or aromatic group, optionally substituted with one or more heteroatoms selected from the group consisting of N, O, S, and P.

Embodiment 14. The method of any of the preceding Embodiments, wherein the end-capping agent comprises at least one polymeric carbodiimide having a molecular weight from about 20 to about 5000 Daltons, as determined by ASTM 5296-19.

Embodiment 15. The method of any of the preceding Embodiments, wherein the end-capping agent comprises at least one diisocyanate according to Formula (II)

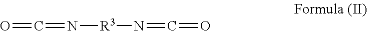

wherein R³ comprises an aliphatic or aromatic group having from 1 to 20 carbon atoms.

Embodiment 16. The method of any of the preceding Embodiments, wherein the end-capping agent comprises at least one aliphatic or aromatic epoxide having from 2 to 200 carbon atoms.

Embodiment 17. The method of any of the preceding Embodiments, wherein the end-capping agent comprises at least one poly(epoxide) having a molecular weight from about 40 to about 5000 Daltons, as determined by ASTM 5296-19.

Embodiment 18. The method of any of the preceding Embodiments, wherein the at least one acid anhydride is an aliphatic cyclic acid anhydride having from 3 to 40 carbon atoms.

Embodiment 19. The method of any of the preceding Embodiments, wherein the at least one acid anhydride comprises at least one cyclic anhydride selected from the group consisting of maleic anhydride, succinic anhydride, octadecenyl succinic anhydride, and mixtures thereof.

Embodiment 20. The method of any of the preceding Embodiments, wherein the reacting step is carried out at a temperature from about 120° C. to about 200° C.

Embodiment 21. The method of any of the preceding Embodiments, wherein the peroxide is an organic peroxide.

Embodiment 22. The method of any of the preceding Embodiments, wherein the peroxide is selected from the group consisting of lauryl peroxide, dicumyl peroxide, and 2,5-Bis(tert-butylperoxy)-2,5-dimethylhexane

Embodiment 23. The method of any of the preceding Embodiments, wherein the reacting step is carried out in an extruder.

Embodiment 24. The method of any of the preceding Embodiments, wherein the reacting step is carried out in a continuous mixer.

Embodiment 25. The method of any of the preceding Embodiments, wherein the reacting step is carried out at a temperature from about 120° C. to about 200° C.

Embodiment 26. A polymer composition comprising at least 50 weight percent of the end-capped and grafted poly(hydroxyalkanoate) formed according to any of the preceding Embodiments.

### EXAMPLES

The following non-limiting examples illustrate various additional aspects of the invention. Unless otherwise indicated, temperatures are in degrees Celsius and percentages are by weight based on the dry weight of the formulation.

Example 1. A poly(hydroxyalkanoate) consisting of 94% of hydroxybutyrate repeat units and 6% of hydroxyhexanoate repeat units was charged in a twin-screw extruder with 1% of a nucleator (pentaerythritol) and compounded at a melt temperature of about 182° C. The resulting pellets were analyzed for molecular weight under ASTM 5296-19. The pellets were then converted into molded plaques via injection molding and measured for Hunter color and molecular weight ASTM E1347 and ASTM 5296-19, respectively. The percent change in molecular weight after molding was calculated, and this value, along with the Hunter color, was utilized as a control for comparison in Table 1.

Example 2. A poly(hydroxyalkanoate) consisting of 94% of hydroxybutyrate repeat units and 6% of hydroxyhexanoate repeat units was charged in a twin-screw extruder with 1% nucleator (pentaerythritol) and 2% of Stabaxol P, a commercially available carbodiimide, and compounded at a melt temperature of about 182° C. The resulting pellets were analyzed for molecular weight under ASTM 5296-19. The pellets were then converted into molded plaques via injection molding and measured for the yellowness index via Hunter color and molecular weight ASTM E1347 and ASTM 5296-19, respectively. The percent change in molecular weight after molding was calculated, and this value and the Hunter color were compared to the control (Example 1) in Table 1. The sample shows a lower percent change in molecular weight and a lower yellowness index compared to the control, indicating successful acid/degradation mitigation.

Example 3. A poly(hydroxyalkanoate) consisting of 94% of hydroxybutyrate repeat units and 6% of hydroxyhexanoate repeat units was charged in a twin-screw extruder with 1% nucleator (pentaerythritol) and 0.1% of dicumyl peroxide, and compounded at a melt temperature of about 182° C. The resulting pellets were analyzed for molecular weight under ASTM 5296-19. The pellets were then converted into molded plaques via injection molding and measured for the yellowness index via Hunter color and molecular weight ASTM E1347 and ASTM 5296-19, respectively. The percent change in molecular weight after molding was calculated, and this value, along with the Hunter color, was compared to the control in Table 1. The sample shows a lower percent change in molecular weight and a lower yellowness index compared to the control, indicating successful acid/degradation mitigation.

Example 4. A poly(hydroxyalkanoate) consisting of 94% of hydroxybutyrate repeat units and 6% of hydroxyhexanoate repeat units were charged in a twin-screw extruder with 1% nucleator (pentaerythritol), 0.1% of dicumyl peroxide, and 2.0% of succinic anhydride and compounded at a melt temperature of about 182° C. The resulting pellets were analyzed for molecular weight under ASTM 5296-19. The pellets were then converted into molded plaques via injection molding and measured for the yellowness index via Hunter color and molecular weight ASTM E1347 and ASTM 5296-19, respectively. The percent change in molecular weight after molding was calculated, and this value, along with the Hunter color, was compared to the control in Table 1. The sample shows a lower percent change in molecular weight and a lower yellowness index compared to the control, indicating successful acid/degradation mitigation.

Example 5. A poly(hydroxyalkanoate) consisting of 94% of hydroxybutyrate repeat units and 6% of hydroxyhexanoate repeat units were charged in a twin-screw extruder with 1% nucleator (pentaerythritol), 0.1% of dicumyl peroxide, and 1.0% of maleic anhydride and compounded at a melt temperature of about 182° C. The resulting pellets were analyzed for molecular weight under ASTM 5296-19. The pellets were then converted into molded plaques via injection molding and measured for the yellowness index via Hunter color and molecular weight ASTM E1347 and ASTM 5296-19, respectively. The percent change in molecular weight after molding was calculated, and this value, along with the Hunter color, was compared to the control in Table 1. The sample shows a lower percent change in molecular weight and a lower yellowness index compared to the control, indicating successful acid/degradation mitigation.

TABLE 1

| | Weight Average Molecular | Hunter Color |
|---|---|---|
| Sample | Weight % Change | Yellowness Index |
| Example 1 | 65.97% | 55.32 |
| Example 2 | 17.16% | 26.12 |
| Example 3 | 10.78% | 27.45 |
| Example 4 | 9.28% | 27.29 |
| Example 5 | 11.92% | 32.33 |

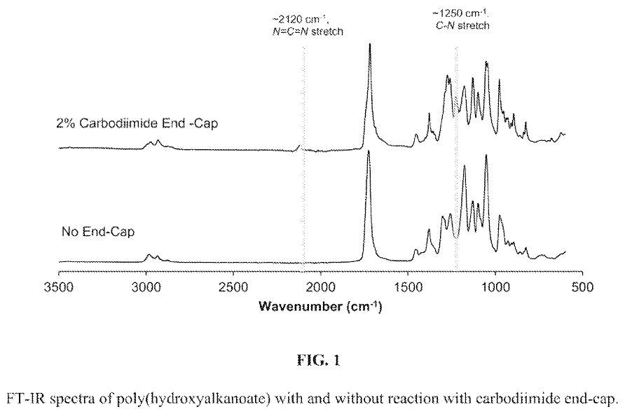

Example 6. A poly(hydroxyalkanoate) consisting of 94% of hydroxybutyrate repeat units and 6% of hydroxyhexanoate repeat units was charged in a twin-screw extruder with 1% nucleator (pentaerythritol) and 2.0% of a polymeric carbodiimide, and compounded at a melt temperature of about 182° C. In comparison to a control sample (Example 1), this reaction with the polymeric carbodiimide is characterized by an increase in molecular weight as measured by ASTM 5296-19 and a reduction in acid value from about 0.7 to 0.2 as measured by titration with a potassium hydroxide (KOH) solution, as shown in the in Table 2 below. Additionally, the end-cap reaction is confirmed by the formation of new carbon-nitrogen (C—N) bonds as captured by FT-IR spectroscopy, as illustrated in FIG. 1. In the FT-IR spectrum of 2% end-capped poly(hydroxyalkanoate), a new C—N stretch appears as well around 1250 cm⁻¹, and N═C═N stretches around 2120 cm⁻¹, which indicates unreacted residual carbodiimide.

TABLE 2

| | Example1 (Control) | Example 6 |
|---|---|---|
| Weight Average Molecular | 392 | 646 |
| Weight (Mw) (kilodaltons) | | |
| Number Average Molecular | 193 | 246 |
| Weight (Mn) (kilodaltons) | | |
| Polydispersity Index (PDI) | 2.0 | 2.6 |
| Acid Value | 0.7 | 0.2 |

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application and to thereby enable one of ordinary skill in the art to utilize the disclosure in various embodiments and with various modifications as are suited to the particular use contemplated.

1. A method for mitigating polymer degradation in poly(hydroxyalkanoates), the method comprising:
combining at least one poly(hydroxyalkanoate) with an end-capping agent, at least one acid anhydride, and a peroxide to form a reaction mixture comprising at least 50 weight percent of the at least one poly(hydroxyalkanoate), from 0.01 to 15 weight percent of the end-capping agent, from 0.01 to 15 weight percent of the acid anhydride, and from 0.01 to 0.5 weight percent of the peroxide, wherein the at least one poly(hydroxyalkanoate) comprises carboxylic acid end groups and monomeric repeat units which are susceptible to degradation to form unsaturated carboxylic acid by-products;
reacting the end-capping agent with the carboxylic acid end groups to form end-capping groups on the at least one poly(hydroxyalkanoate); and
reacting the at least one acid anhydride and the peroxide with the at least one poly(hydroxyalkanoate) to graft side chains formed from the acid anhydride onto the at least one poly(hydroxyalkanoate,
wherein the end-capping agent comprises at least one compound selected from the group consisting of carbodiimides, diisocyanates, epoxides, and mixtures thereof, and
wherein the at least one acid anhydride comprises a cyclic or noncyclic acid anhydride having from 3 to 40 carbon atoms.

2. The method of claim 1, wherein the at least one poly(hydroxyalkanoate) has an initial weight average molecular weight before combining with the end-capping agent and the acid anhydride, of at least 10,000 Daltons, as determined by ASTM 5296-19.

3. (canceled)

4. The method of claim 1, wherein the at least one poly(hydroxyalkanoate) comprises 3-hydroxybutyrate monomeric repeat units, which are susceptible to degradation to form crotonic acid.

5. The method of claim 1, wherein the at least one poly(hydroxyalkanoate) comprises 3-hydroxyhexanoate monomeric repeat units, which are susceptible to degradation to form hexenoic acid.

6. The method of claim 1, wherein the at least one poly(hydroxyalkanoate) comprises 3-hydroxypropionate monomeric repeat units, which are susceptible to degradation to form acrylic acid.

7. The method of claim 1, wherein the at least one poly(hydroxyalkanoate) comprises 4-hydroxybutyrate monomeric repeat units, which are susceptible to degradation to form 4-hydroxybutyric acid.

8. The method of claim 1, wherein the at least one poly(hydroxyalkanoate) comprises poly-3-hydroxybutyrate-co-3-hydroxyhexanaote (P3HB-co-P3HHx).

9. The method of claim 1, wherein the at least one poly(hydroxyalkanoate) comprises polyhydroxybutyrate homopolymer.

10. The method of claim 1, wherein the at least one poly(hydroxyalkanoate) comprises poly-3-hydroxybutyrate-co-3-hydroxyvalerate.

11. The method of claim 1, wherein the at least one poly(hydroxyalkanoate) comprises from 0.1 to 25 mole percent monomer residues of a 3-hydroxyalkanoate selected from the group consisting of 3-hydroxyhexanoate, 3-hydroxyoctanoate, 3-hydroxydecanoate, and mixtures thereof.

12. The method of claim 1, wherein the at least one poly(hydroxyalkanoate) comprises a polyhydroxyalkanoate terpolymer made up from 75 to 99.9 mole percent monomer residues of 3-hydroxybutyrate, from 0.1 to 25 mole percent monomer residues of 3-hydroxyhexanoate, and from 0.1 to 25 mole percent monomer residues of a third 3-hydroxyalkanoate selected from the group consisting of 3-hydroxyoctanoate, 3-hydroxydecanoate, and mixtures thereof.

13. The method of claim 1, wherein the end-capping agent comprises at least one carbodiimide according to Formula (I) 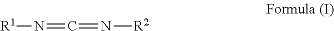
wherein R¹ and R² independently comprise an aliphatic or aromatic group, optionally substituted with one or more heteroatoms selected from the group consisting of N, O, S, and P.

14. (canceled)

15. The method of claim 1, wherein the end-capping agent comprises at least one diisocyanate according to Formula (II) 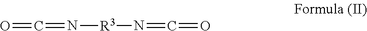
wherein R³ comprises an aliphatic or aromatic group having from 1 to 20 carbon atoms.

16. The method of claim 1, wherein the end-capping agent comprises at least one aliphatic or aromatic epoxide having from 2 to 200 carbon atoms.

17. (canceled)

18. The method of claim 1, wherein the at least one acid anhydride is an aliphatic cyclic acid anhydride having from 3 to 40 carbon atoms.

19. The method of claim 1, wherein the at least one acid anhydride comprises at least one cyclic anhydride selected from the group consisting of maleic anhydride, succinic anhydride, octadecenyl succinic anhydride, and mixtures thereof.

20. The method of claim 1, wherein the reacting step is carried out at a temperature from 120° C. to 200° C.

21. The method of claim 1, wherein the peroxide is an organic peroxide.

22. (canceled)

23. The method of claim 1, wherein the reacting step is carried out in an extruder or in a continuous mixer

24-25. (canceled)

26. A polymer composition comprising at least 50 weight percent of the end-capped and grafted poly(hydroxyalkanoate) formed according to claim 1.
